(19) United States
(12) Patent Application Publication
(10) Pub. No.: US 2026/0225493 A1
(43) Pub. Date: Aug. 6, 2026

(54) SYSTEMS AND METHODS FOR FACILITATING VEHICLE BOOST CHARGING

(71) Applicant: Ford Global Technologies, LLC, Dearborn, MI (US)

(72) Inventors: Kai Wu, PITTSBURGH, PA (US); Dominique Meroux, Ann Arbor, MI (US); Su Yu, Troy, MI (US); Ruthwik Reddy Junuthula, Farmington Hills, MI (US)

(73) Assignee: Ford Global Technologies, LLC, Dearborn, MI (US)

(21) Appl. No.: 19/046,198

(22) Filed: Feb. 5, 2025

(51) Int. Cl. B60L 58/16; B60L 53/62; B60L 53/68; B60L 58/12

(52) U.S. Cl. CPC B60L 58/16; B60L 53/62; B60L 53/68; B60L 58/12; B60L 2240/72; B60L 2250/00

(57) ABSTRACT

A system including a transceiver and a processor is disclosed. The transceiver may receive a request to boost charge a vehicle battery associated with a vehicle. The request may include information associated with at least one of a target State of Charge (SOC) level, a predefined time by which the target SOC level is required, or a minimum distance required to reach a destination. The processor may estimate an extent of a change in a battery state of health (SOH) due to boost charging of the vehicle battery based on the request, and perform a predetermined action based on the estimated extent.

### FIELD

The present disclosure relates to electric vehicles (EVs), and more specifically to systems and methods for facilitating boost charging of EVs.

### BACKGROUND

As awareness of green technology is increasing, battery electric vehicles (BEVs) and plug-in hybrid electric vehicles are gaining popularity. An Electric Vehicle (EV) operates on electric energy, and a vehicle user is required to charge a vehicle battery using EV chargers.

There exist many factors affecting vehicle battery aging including topping up behavior, excessive DC fast charging, overcharging/undercharging, the use of vehicle-to-grid/home (discharging), leaving the battery fully charged or drained for extended periods, the use of battery preconditioning features, battery usage under harsh weather conditions like high-heat climates, and/or the like.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a block diagram of a vehicle charger optimization system for optimizing vehicle charging in accordance with the present disclosure.

FIG. 3 depicts an example process for vehicle boost charging while managing a battery State of Health (SOH), in accordance with the present disclosure.

FIG. 4 depicts an example graph illustrating an exemplary effect of a boost charging event on a battery SOH in accordance with the present disclosure.

FIG. 5 depicts a flow diagram of an example first method to optimize vehicle charging in accordance with the present disclosure.

FIG. 6 depicts an example view of interaction between a vehicle and a charging station for boost charging in accordance with the present disclosure.

FIG. 7 depicts an example boosted charging graph in accordance with the present disclosure.

FIG. 8 depicts a flow diagram of an example second method to optimize vehicle charging in accordance with the present disclosure.

### DETAILED DESCRIPTION

### Overview

The present disclosure describes a vehicle charging optimization system (“system”) that may facilitate a user to boost charge a user's vehicle (which may be an Electric Vehicle (EV)), while managing a battery State of Health (SOH). The user may transmit a request to the system to facilitate boost charging of vehicle (e.g., beyond typical “C rate” that refers to the rate at which a battery can be charged or discharged relative to its capacity). The user may transmit the request via a user device or a vehicle Human-Machine Interface (HMI), when the user desires to boost charge the vehicle in urgent scenarios. The request may include information associated with at least one of a target State of Charge (SOC) level, a predefined time by which the target SOC level is required, or a minimum distance required to reach a destination. For example, the user may indicate in the request that the user desires to charge the vehicle battery from 20% to 80% in 30 minutes as the user has to travel and attend an urgent meeting.

The system may receive the request and may estimate an extent in a change of the battery SOH based on the request. Responsive to estimating the extent, the system may perform a predetermined action. In some aspects, the system may search for available chargers based on the request and determine a time required by the vehicle to travel from a vehicle current location to the respective charging station. The system may determine a desired charging power curve (or desired charging rate) to boost charge the vehicle battery based on the request, the travel time, and one or more vehicle battery current parameters (e.g., current battery SOC level).

To estimate the extent in the change of battery SOH due to boost charging, the system may simulate the vehicle battery behavior or performance. For instance, the system may simulate a current boosted charging curve based on the desired charging power curve, and simulate a future charging curve based on user's historical charging behavior. Responsive to simulating the current boosted charging curve and the future charging curve, the system may predict an updated battery SOH due to boost charging of the vehicle battery based on the current boosted charging curve and an original battery SOH. The system may calculate a difference between the updated battery SOH and the original battery SOH, and estimate the extent of a change in the battery SOH based on the difference.

The system may further perform the predetermined action based on the estimated extent. In one exemplary aspect, as part of the predetermined action, the system may output a notification indicating the estimated extent of respective charging station. In further aspects, the system may output a recommendation of battery's future charging speed profile (or current limits) to minimize the effect of battery degradation due to boost changing, when the system determines that the effect of boost charging may be mitigated. For example, the system may output a notification recommending the user to have 5-10 “mild” charging profiles for the vehicle battery in future charging events to mitigate the effects of boost charging. The user may receive/view the notification and accept the offer to boost charge the vehicle battery. In this manner, the user may use boost charging in urgent scenarios and may use normal charging for the next few charging cycles to minimize the effect of boost charging. On the other hand, when the system determines that the effect of boost charging may not be mitigated, the system may output flexible warranty packages to the user.

The present disclosure discloses a vehicle charging optimization system that facilitates boost charging while managing battery SOH, thereby enhancing battery performance. For example, the system allows the user to charge the vehicle battery at increased charging speeds during critical situations, addressing urgent travel needs without compromising long-term battery health. Unlike traditional systems with static charging curves, this dynamic system allows for temporary performance boosts tailored to the user's immediate requirements. In addition, the system integrates battery charging control modules and EVSE high-voltage chargers, which efficiently balances charging speed and battery SOH. This integration ensures that boost charging can occur with minimal effect on battery longevity and warranty conditions. The system further offers adaptive battery health management. The system intelligently adjusts future charging sessions to mitigate any temporary SOH impairment, promoting battery recovery and maintaining performance within acceptable limits. This proactive management prevents long-term degradation.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

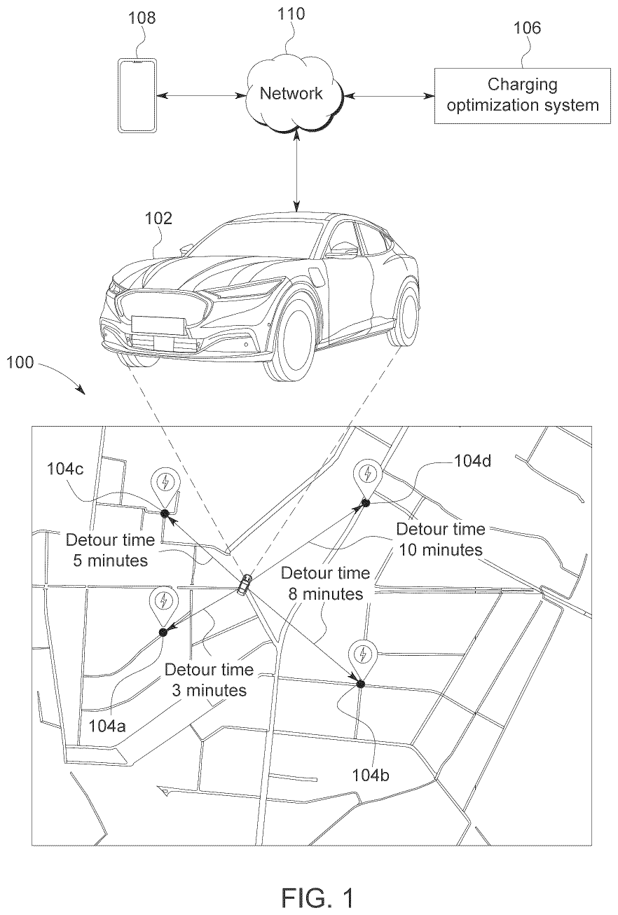

FIG. 1 depicts an environment 100 in which techniques and structures for providing the systems and methods disclosed herein may be implemented. The environment 100 may include a vehicle 102 that may be a battery electric vehicle (BEV). The vehicle 102 may take the form of any passenger or commercial vehicle such as an off-road vehicle, a car, a crossover vehicle, a van, a minivan, a bus, a truck, etc. Further, the vehicle 102 may be a manually driven vehicle and/or may be configured to operate in partially or fully autonomous mode. In further aspects, the vehicle 102 may be a plug-in hybrid electric vehicle (PHEV). When the vehicle 102 is PHEV, the vehicle 102 may be equipped with an internal combustion engine that can be employed either alone or in combination with other energy sources to propel the vehicle 102.

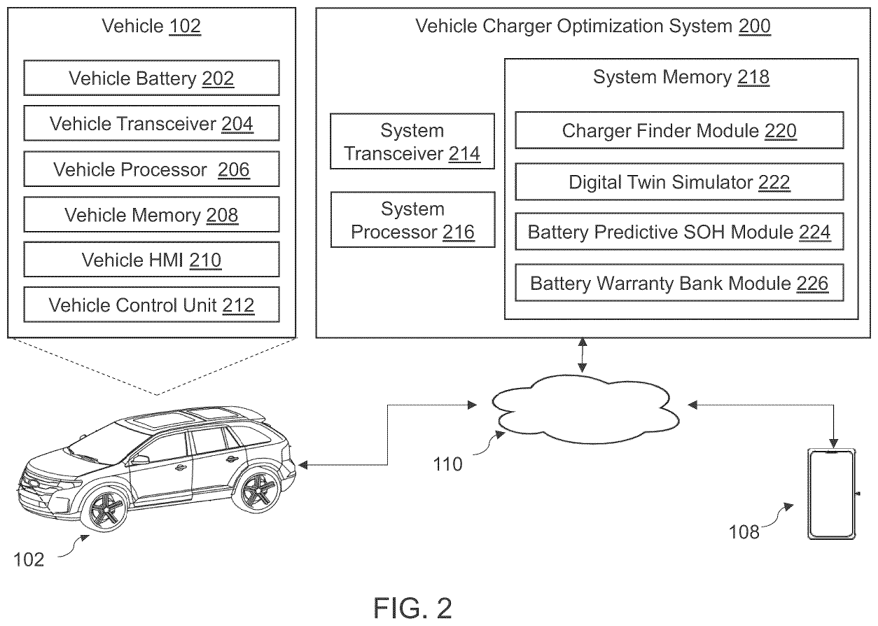

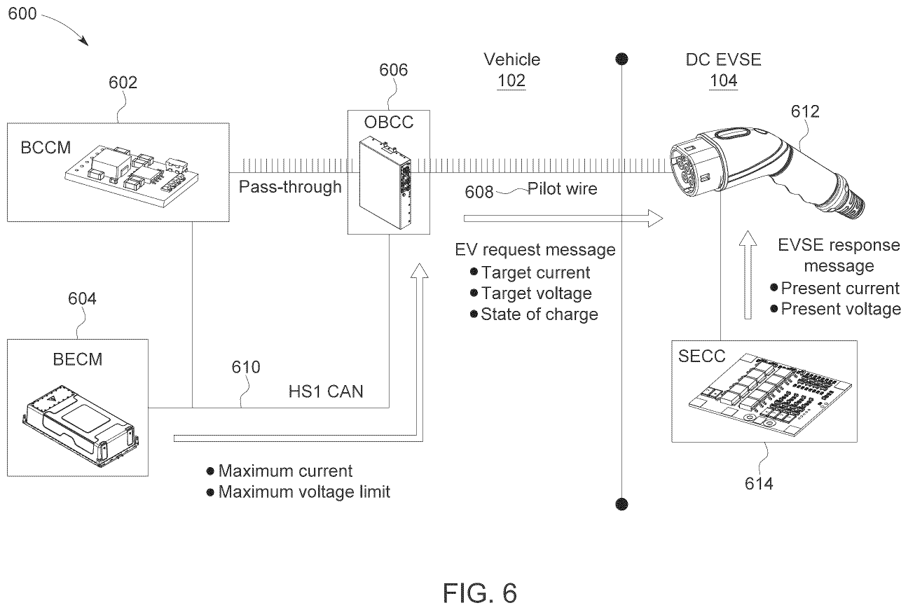

The environment 100 may further include a plurality of charging stations 104a, 104b, 104c (collectively referred to as charging stations 104). Each charging station 104 may supply current to a vehicle traction battery or vehicle battery (shown as vehicle battery 202 in FIG. 2) that may provide energy for vehicle propulsion. Each charging station 104 may include a connecting device that may connect the charging station 104 and the vehicle 102. The connecting device may include a cable and a cable connector (shown as connector 612 in FIG. 6) that may be inserted in the vehicle 102 for charging. In particular, when a vehicle user (not shown) desires to charge the vehicle 102, the user may insert the cable connector in the vehicle 102.

In an exemplary aspect, the charging station 104 may include a plurality of Electric Vehicle Supply Equipment (EVSE) or chargers configured to supply alternating current (AC) power or supply direct current (DC) power to the vehicle battery. The DC power may enable fast charging of the vehicle battery. Stated another way, the DC power may provide sufficient charge to the vehicle battery in relatively short time duration (e.g., 50% in 10-15 minutes). In some aspects, the vehicle 102 may include power converters (not shown) such as AC to DC converter, DC to DC converter, etc. A person ordinarily skilled in the art may appreciate that the AC to DC converter may convert AC power from the charging station 104 to DC power that may be supplied to the vehicle battery. Further, the DC-to-DC converter may convert a first DC voltage to a second DC voltage for different vehicle functions.

The environment 100 may further include a vehicle charging optimization system 106 that may be connected to the vehicle 102 and a user device 108 associated with the user, via one or more networks 110. The network(s) 110 illustrates an example communication infrastructure in which the connected devices discussed in various embodiments of this disclosure may communicate. The network(s) 110 may be and/or include the Internet, a private network, public network or other configuration that operates using any one or more known communication protocols such as transmission control protocol/Internet protocol (TCP/IP), Bluetooth®, BLE®, Wi-Fi based on the Institute of Electrical and Electronics Engineers (IEEE) standard 802.11, Ultra-Wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples. In some aspects, the user device 108 may be, for example, a mobile phone, a laptop, a computer, a smartwatch, or any other device with communication capacities.

The vehicle charging optimization system 106 (or system 106) may optimize vehicle charging for the vehicle 102 (and a plurality of other vehicles that may be communicatively coupled with the system 106). For example, in some scenarios, the user may desire to boost charge the vehicle 102 (e.g., via a DC charger). In such scenarios, the system 106 may enable boost charging of the vehicle battery while managing (or preventing substantial degradation of) a battery State of Health (SOH). In some aspects, to optimally manage the battery SOH, the system 106 may first estimate an extent of a change in the battery SOH due to boost charging of the vehicle battery, and then perform a predetermined action based on the extent. For example, the system 106 may adjust/recommend future charging sessions to minimize the effect of boost charging on the vehicle battery/SOH (e.g., to realign battery degradation to acceptable levels), or the system 106 may offer flexible warranty packages to the user (e.g., when the battery degradation cannot be mitigated), thereby ensuring user satisfaction and/or vehicle battery longevity. An example process implemented by the system 106 to manage the battery SOH is briefly described below.

In some aspects, the system 106 may first receive a user request to boost charge the vehicle 102, via the user device 108 or via a vehicle Human Machine Interface (HMI) (shown as vehicle HMI 210 in FIG. 2). The request may include information associated with a target State of Charge (SOC) level, a predefined time by which the target SOC level is required, and/or a minimum distance required to reach a destination location associated with a vehicle trip. For example, the user may indicate in the user request that the vehicle battery should be charged from 20% to 80% in 30 minutes as the user has to travel and attend an urgent meeting.

Responsive to receiving the user request (“request”), the system 106 may obtain/fetch charging station information from a system memory (shown as system memory 218 in FIG. 2) or an external server (not shown). The charging station information may include charging station availability status, charging station location, etc. The system 106 may identify available charging stations near the vehicle 102 or located in a vehicle route (e.g., the charging stations 104a, 104b, 104c, shown in FIG. 1) based on the charging station information. The system 106 may further determine a time required by the vehicle 102 to travel from a vehicle current location to the respective charging station (that may be available) based on the charging station information (e.g., 3 minutes to reach the charging station 104a, 8 minutes to reach the charging station 104b, etc., as shown in FIG. 1).

In addition, for each available charging station, the system 106 may determine a desired charging power curve (that indicates desired power that should be delivered to the vehicle battery over time) or a desired charging rate to boost charge the vehicle battery. The system 106 may determine the desired charging power curve (or the desired charging rate) based on the time required by the vehicle 102 to travel from the vehicle's current location to the respective charging station location, one or more vehicle battery's current parameters (e.g., current battery SOC level), and the user request. In some aspects, the system 106 may first determine a desired charging time for the vehicle 102 at each available charging station based on the time required by the vehicle 102 to travel from the vehicle's current location to the respective charging station and the user request. Responsive to determining the desired charging time at each available charging station, the system 106 may determine the desired charging power curve or the desired charging rate at each available charging station.

Generally, the current that is supplied to a vehicle battery is at 1 C (also referred to as the “C rate” of 1) or lower. “C” or “C rate” is a measure of the rate at which a battery is charged or discharged relative to its capacity. The C rate is defined as the charge or discharge current divided by the battery's stored charge capacity. The C rate of 1 (also called 1 C) is the current level that fully discharges (or charges) the battery within one hour, and the C rate of 2 (2 C) is the current level that will fully discharge (or charge) the battery in half an hour (30 minutes). The charging time of the battery can be reduced by increasing the C rate of the charging process.

In an example, when the user desires to charge the vehicle 102 in 30 minutes and the charging station 104a is 3 minutes away from the vehicle's current location and the charging station 104b is 8 minutes away from the vehicle's current location, the desired charging time for the charging station 104a needs to be 27 minutes (or less) and the desired charging time for the charging station 104b needs to be 22 minutes (or less). To charge the vehicle battery in the desired charging time, instead of using a 1 C charging rate, the system 106 may boost the charging rate to 1.1 C (as an example) for the charging station 104a or the system 106 may boost the charging rate to 1.25 C (as an example) for the charging station 104b. 1.1 C or 1.25 C may be indicative of the desired charging rate at the charging stations 104a, 104b respectively.

Responsive to determining the desired charging power curve or the desired charging rate for each charging station, the system 106 may estimate the extent of change in the battery SOH for each charging station (e.g., if the vehicle battery gets charged at the respective charging station). Stated another way, the system 106 may determine an extent of battery degradation that may be caused due to boost charging, when the vehicle 102 is charged at the charging station 104a or the charging station 104b, etc. The details of the estimation of the extent of change in battery SOH is described later in the description below.

The system 106 may further perform the predetermined action based on the estimated extent. In one exemplary aspect, as part of the predetermined action, the system 106 may output a notification indicating the estimated extent of battery degradation at respective charging station. In further aspects, the system 106 may output a recommendation of battery's future charging speed profile (or current limits) to minimize the effect of battery degradation due to boost changing. For example, the system 106 may output a notification recommending the user to have 5-10 “mild” charging profiles for the vehicle battery in future charging events (e.g., perform AC charging and not fast/DC charging for the next 5-10 charging events). The user may receive/view the notification and accept the offer to boost charge the vehicle battery (e.g., if the user is fine with having 5-10 mild charging sessions for the vehicle battery in the future). In this manner, the user may use boost charging in urgent scenarios and may use AC charging for the next few charging cycles to minimize the effect of boost charging. In some aspects, the notification may additionally include the identifier/location of the respective charging stations, so that the user may select an optimal charging station and drive the vehicle 102 to the optimal charging station and boost charge the vehicle battery.

In another exemplary aspect, the user may indicate in the request that the user desires to have 100 miles of range by 5 PM. In this case, the system 106 may determine/predict a route associated with a vehicle trip, and may identify available charging station(s) that may be located in the route based on the request to enable the vehicle battery to have 100 miles of range by 5 PM.

Although the present disclosure describes that the system 106 receives the request from the user via the user device 108 and/or the vehicle HMI, the present disclosure should not be construed as limited to this aspect. In alternative aspects, the system 106 may obtain the request from an EV trip planner that may be located on a server/cloud.

The vehicle 102 and the system 106 implement and/or perform operations, as described here in the present disclosure, in accordance with the owner manual and safety guidelines. In addition, any action taken by the user should comply with all the rules specific to the location and operation of the vehicle 102 (e.g., Federal, state, country, city, etc.). The notifications/recommendations, as provided by the vehicle 102 or the system 106, should be treated as suggestions and only followed according to any rules specific to the location and operation of the vehicle 102.

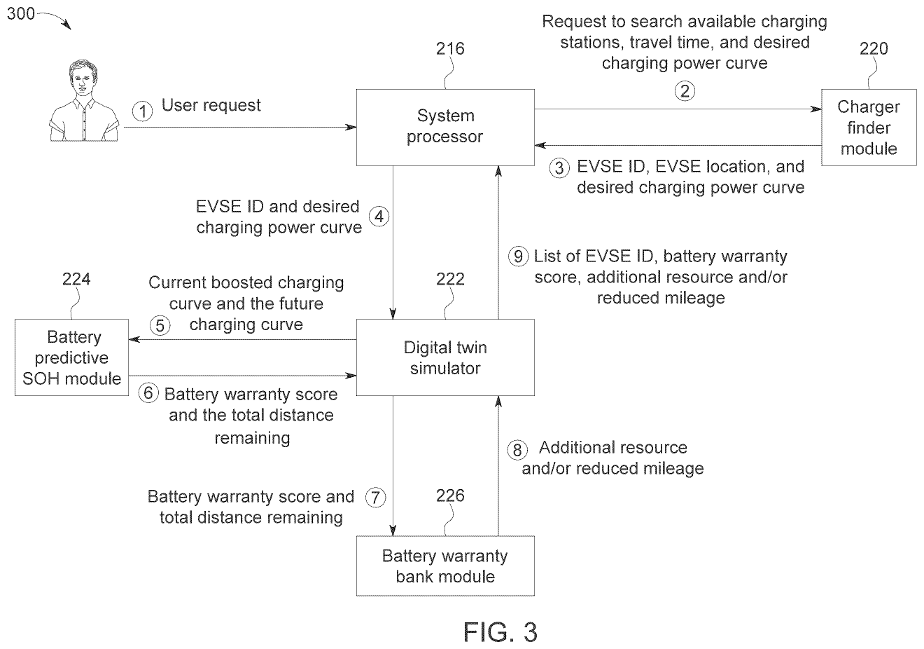

FIG. 2 depicts a block diagram of a vehicle charger optimization system 200 for optimizing vehicle charging in accordance with the present disclosure. FIG. 2 will be described in conjunction with FIG. 3.

The vehicle charger optimization system 200 (or system 200) may be the same as the vehicle charging optimization system 106 described above in conjunction with FIG. 1. The system 200, as described herein, can be implemented in hardware, software (e.g., firmware), or a combination thereof. In some aspects, the system 200 may be hosted on a server, a cloud or a distributed computing system. In some aspects, the system 200 may be communicatively coupled to the vehicle 102 and the user device 108 via the network 110. In other aspects, the system 200 may be part of the vehicle 102.

The vehicle 102 may include a plurality of components including, but not limited to, a vehicle battery 202, a vehicle transceiver 204, a vehicle processor 206, a vehicle memory 208, a vehicle Human Machine Interface (HMI) 210, a vehicle control unit 212, and/or the like. The vehicle transceiver 204 may transmit/receive information or instructions to/from the system 200, the user device 108, etc., via the network 110. For example, the vehicle transceiver 204 may transmit one or more vehicle battery's current parameters (and/or other vehicle information) to the system 200. In some aspects, the vehicle battery's current parameters may include a current battery State of Charge (SOC) level, a battery age, a battery type, and/or the like. In addition, the vehicle transceiver 204 may transmit the request (or the user request received via the vehicle HMI 210, as described above in conjunction with FIG. 1) to the system 200. Further, the vehicle transceiver 204 may receive one or more notifications from the system 200, which may indicate the effect of boost charging on the vehicle battery and/or one or more recommendations to minimize the boost charging effect.

The vehicle processor 206 may be disposed in communication with one or more memory devices (e.g., the vehicle memory 208 and/or one or more external databases not shown in FIG. 2). The vehicle processor 206 may utilize the vehicle memory 208 to store programs in code and/or to store data for performing various vehicle 102 operations in accordance with the present disclosure. The vehicle memory 208 may be a non-transitory computer-readable memory. The vehicle memory 208 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc. The vehicle control unit 212 may include a battery charge control module (BCCM), a battery energy control module (BECM) and an off-board charge control module (OBCC), which are described later in the description below in conjunction with FIG. 6.

The system 200 may include a plurality of units including, but not limited to, a system transceiver 214, a system processor 216 and a system memory 218. In some aspects, the system transceiver 214 may receive the request from the user to boost charge the vehicle battery 202, via the user device 108 or the vehicle HMI 210. Further, the system transceiver 214 may transmit one or more notifications to the user via the user device 108 or the vehicle HMI 210. In addition, the system transceiver 214 may receive the vehicle battery's current parameters (and/or other vehicle information) from the vehicle transceiver 204. In addition, the system transceiver 214 may receive information/data/signals from an external server (not shown). For example, the system transceiver 214 may receive charging station information associated with the plurality of charging stations 104a, 104b, 104c, such as their availability status, location, and/or the like.

As described above in conjunction with FIG. 1, the request for boost charging provided by the user may include information associated with a target State of Charge (SOC) level, a predefined time by which the target SOC level is required, and/or a minimum distance required to reach a destination location. For example, the user may indicate in the request that the user desires to charge the vehicle battery 202 from 20% to 80% in 30 minutes or the user may indicate in the request that the user desires to have 100 miles of range by 5 PM.

The system processor 216 may be disposed in communication with one or more memory devices, e.g., the system memory 218 and/or one or more external databases (not shown in FIG. 2). The system processor 216 may utilize the system memory 218 to store programs in code and/or to store data for performing various system operations in accordance with the present disclosure. The system memory 218 may be a non-transitory computer-readable memory storing a charger optimization program code. The system memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.

In some aspects, the system memory 218 may include a plurality of modules including, but not limited to, a charger finder module 220, a digital twin simulator 222, a battery predictive SOH module 224, a battery warranty bank module 226, and/or the like. These modules may be stored in the form of computer-executable instructions and the system processor 216 may execute the stored computer-executable instructions for performing functions/operations in accordance with the present disclosure.

The functions of the system components and their interactions with each other is described below in conjunction with an example process depicted in FIG. 3.

In some aspects, the system processor 216 may first obtain the request from the user via system transceiver 214, as shown in step “1” of FIG. 3. As described above, the request obtained from the user may include information associated with the target SOC level, the predefined time by which the target SOC level is required and/or the minimum distance required to reach a destination. Alternatively, the system processor 216 may obtain such information from the server or the vehicle 102 (e.g., from an EV trip planner). The system processor 216 may use the modules stored in the system memory 218 to facilitate boost charging of the vehicle battery 202 based on the obtained request, while minimizing the effect on the battery SOH due to the boost charging event.

Responsive to receiving the boost charging request from the user, the system processor 216 may request the charger finder module 220 to search for available charging stations, and determine a time to travel from the vehicle's current location to the respective charging station, a desired charging power curve (or a desired charging rate) to boost charge the vehicle battery 202 for the respective charging station, as shown in step “2” of FIG. 3.

Responsive to obtaining the request from the system processor 216, the charger finder module 220 may identify one or more charging stations that may be available to charge the vehicle battery 202. In some aspects, the charger finder module 220 may fetch the charging station information associated with the charging stations 104 (e.g., their real-time availability status, location, etc.) from the server, and may then identify one or more charging stations that may be available to charge the vehicle battery 202 based on the charging station information. In addition, the charger finder module 220 may calculate or determine a time required by the vehicle 102 to travel from the vehicle's current location to the respective charging station, with an added buffer for boosted current (including communication time between the vehicle 102 and the charging station 104). In some aspects, the charger finder module 220 may determine the time required by the vehicle 102 to travel from the vehicle current's location to the respective charging station based on the charging station information.

In some aspects, for each charging station, the charger finder module 220 may determine the desired charging power curve (or a desired charging rate) to boost charge the vehicle battery 202 based on the request obtained from the user, the time required by the vehicle 102 to travel from the vehicle's current location to the respective charging station, and one or more vehicle battery's current parameters (e.g., current battery SOC level). Specifically, as described above in conjunction with FIG. 1, the charger finder module 220 may first determine a desired charging time based on the time required by the vehicle 102 to travel from the vehicle's current location to the respective charging station and the user request. Based on the determined desired charging time, the charger finder module 220 may determine the desired charging power curve or the desired charging rate.

A charging power curve may be a graphical representation of the power delivered to a battery over time during a charging session, which shows how the charging power varies throughout the charging process. The charging power curve may include an X axis that represents time or the SOC level, and a Y axis that represents charging power (e.g., in kilowatts). The charging power curve is typically influenced by the battery SOC level, environmental conditions, etc. For example, it is known that a battery charges fast between 20-80% SOC level. A charging power curve may indicate such information in a graphical manner.

Responsive to determining the desired charging power curve or the desired charging rate, the charger finder module 220 may output/transmit the identifier associated with each charging station (or EVSE ID), the location of each charging station, and the desired charging power curve associated with each charging station to the system processor 216, as shown in step “3” of FIG. 3.

The system processor 216 may obtain the EVSE ID, the location, and the desired charging power curve from the charger finder module 220 and may transmit the EVSE ID and the desired charging power curve of each charging station to the digital twin simulator 222, as shown in step “4” of FIG. 3, to determine the extent of change in the battery SOH due to the boost charging event at respective charging station. The digital twin simulator 222 may obtain the EVSE ID and the desired charging power curve, and may create various virtual scenarios associated with the vehicle battery 202. In some aspects, the digital twin simulator 222 may create a virtual representation of the vehicle battery 202 and may be used to simulate the vehicle battery 202 behavior or performance in real-time or over a specific time duration. In some aspects, the digital twin simulator 222 may be used to estimate or determine the effect of a boost charging event on the battery SOH, or to determine the extent of degradation on the battery SOH due to boost charging for different charging stations available to charge the vehicle battery 202.

In some aspects, to perform the task(s) described above, the digital twin simulator 222 may obtain the desired charging power curve for respective charging station from the charger finder module 220, and simulate a current boosted charging curve based on the respective desired charging power curve. Stated another way, the digital twin simulator 222 may determine a charging curve for the vehicle battery 202 when the vehicle battery 202 may be charged according to the respective desired charging power curve. In addition, the digital twin simulator 222 may obtain user's historical charging behavior, and may simulate a future charging curve based on the user's historical charging behavior. In some aspects, the digital twin simulator 222 may use the future charging curve to determine a recommendation to charge the vehicle battery 202 in future. The recommendation may include a future vehicle battery charge speed profile to minimize a degradation rate or change in trajectory of the battery SOH due to boost charging or the effect of a boost charging event on the battery SOH.

In some aspects, the digital twin simulator 222 may further evaluate a charging power buffer (e.g., through a battery charging control module, not shown) that may be required to optimize thermal controls to maintain the vehicle battery 202 at optimal temperatures, to check for potential SOH impairment if the charging current request exceeds threshold levels particularly when the SOC level is above 80%, address potential current/power limitations due to grid constraints, and/or the like. For instance, during high demand periods, the EVSE may reduce charging power to prevent grid overload.

The digital twin simulator 222 may transmit the current boosted charging curve and the future charging curve for respective charging stations to the battery predictive SOH module 224, as shown in step “5” of FIG. 3.

In some aspects, the battery predictive SOH module 224 may obtain the current boosted charging curve and the future charging curve for respective charging stations, from the digital twin simulator 222. The battery predictive SOH module 224 may estimate the battery degradation that may be caused due to boost charging based on the obtained charging curves, for each charging station. To estimate the battery degradation, the battery predictive SOH module 224 may first predict or estimate an updated battery SOH due to boost charging of the vehicle battery 202 based on the current boosted charging curve and an original battery SOH. A battery SOH may be a function of a remaining useable capacity and a useable capacity associated with a new battery (i.e., when the battery is new). The battery predictive SOH module 224 may derive the remaining useable capacity due to boost charging based on the current boosted charging curve, and then determine the updated battery SOH based on the remaining useable capacity and the original battery SOH (that indicates useable capacity associated with the new battery). Responsive to estimating the updated battery SOH, the battery predictive SOH module 224 may calculate a first difference between the updated battery SOH and the original battery SOH, and estimate the extent of change in the battery SOH based on the first difference.

To perform the predetermined action, the battery predictive SOH module 224 may estimate a future battery SOH based on the future charging curve and the respective updated battery SOH, for each charging station. The battery predictive SOH module 224 may calculate a second difference between the respective future battery SOH and the original battery SOH. The battery predictive SOH module 224 may store the future charging curve in the system memory 218 when the second difference between the respective future battery SOH and the original battery SOH is less than a threshold value, to facilitate charging of the vehicle battery 202 based on the future charging curve in future charging events. In some aspects, the battery health degradation due to the boost charging event may be low and the effect of boost charging may be substantially mitigated when the second difference may be less than the threshold value.

In some aspects, the battery predictive SOH module 224 (or the digital twin simulator 222) may determine a recommendation to charge the vehicle battery 202 in future based on the future charging curve when the second difference is less than the threshold value, and output a first notification for the user (via the user device 108/vehicle HMI 210, and/or the system processor 216) indicating the recommendation. The recommendation may include a future vehicle battery charge speed profile to minimize the extent of change in the battery SOH or a degradation rate or change in trajectory of the battery SOH due to boost charging. The first notification may additionally include information associated with those charging stations having the second difference less than the threshold value, such as the identifier associated with the charging stations, the charging station location, the travel time, and/or the like. For example, the battery predictive SOH module 224 may output the notification indicating that the boost charging is doable from the charging station 104a (as the second difference associated with the charging station 104a may be less than the threshold value) but requires 5-10 mild charging profiles in the following charging events to mitigate the SOH impairment generated from this alternative charging solution.

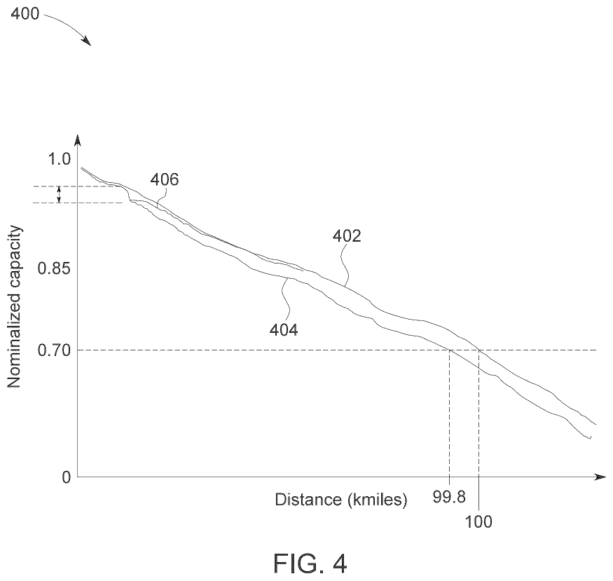

Further, the battery predictive SOH module 224 may calculate/generate a battery warranty score and estimate the total distance remaining based on the current boosted charging curve and the future charging curve (or the updated battery SOH), when the second difference between the future battery SOH and the original battery SOH may be greater than the threshold value. In some aspects, the battery predictive SOH module 224 may derive the total distance remaining using the remaining useable capacity. The process to estimate the total distance remaining is described below in conjunction with FIG. 4.

The battery predictive SOH module 224 may transmit the battery warranty score and the total distance remaining to the digital twin simulator 222, as shown in step “6” of FIG. 3.

The digital twin simulator 222 and the battery predictive SOH module 224 provide sophisticated tools for forecasting battery health outcomes based on current and projected usage (or current boosted charging curve and the future charging curve). This predictive capability supports informed decision-making, enabling users to understand the potential effects of their charging behaviors and make necessary adjustments.

In some aspects, the digital twin simulator 222 may transmit the battery warranty score and the total distance remaining to the battery warranty bank module 226, as shown in step “7” of FIG. 3. The battery warranty bank module 226 may obtain the battery warranty score and the total distance remaining from the digital twin simulator 222, and may quantify the effect of the boost charging on the vehicle battery 202 when the second difference between the future battery SOH and the original battery SOH is greater than the threshold value (or when the battery degradation is greater than an acceptable level). In some aspects, the battery warranty bank module 226 may determine an additional resource required to maintain a battery warranty based on the battery warranty score. In addition, the battery warranty bank module 226 may determine a reduced mileage based on the battery warranty score and the total distance remaining. The battery warranty bank module 226 may determine the additional resource and/or the reduced mileage for those charging stations having second difference greater than the threshold value. The battery warranty bank module 226 may transmit the information associated with the additional resource and/or the reduced mileage to the digital twin simulator 222, as shown in step “8” of FIG. 3.

The digital twin simulator 222 may receive the information associated with the additional resource and/or the reduced mileage from the battery warranty bank module 226. The digital twin simulator 222 may further transmit the EVSE ID, the battery warranty score, the additional resource and/or the reduced mileage to the system processor 216 for each charging station, as shown in step “9” of FIG. 3. In some aspects, the system processor 216 may output a second notification for the user indicating the additional resource required to maintain the battery warranty and/or output a third notification for the user indicating the reduced mileage (e.g., 99,980 miles instead of 100,000 miles that may be associated with the vehicle battery 202 when it was new or before the boost charging event), via the user device 108 and/or the vehicle HMI 210.

In some aspects, the system processor 216 may output the first notification (including the recommendation of future charging sessions) for those charging stations having the second difference less than the threshold value to minimize the effect of boost charging on the vehicle battery 202, or the system processor 216 may output the second/third notification (that may offer flexible warranty packages, information associated with the additional resource(s) and/or the reduced mileage, etc.) for those charging stations having the second difference greater than the threshold value, thereby ensuring user satisfaction and vehicle battery longevity. In some aspects, the system processor 216 may output a single notification that includes the first, second, and third notification. This single notification may indicate the extent of degradation for respective charging stations, in the manner described above, to facilitate the user to accept or reject the offer to boost charge the vehicle 102 and/or to select an optimal charging station to charge the vehicle 102.

In operation, when the user desires to boost charge the vehicle 102, the user may transmit a user request or a request to the system transceiver 214 to facilitate boost charging of the vehicle battery 202, via the user device 108 and/or the vehicle HMI 210. The system transceiver 214 may receive the request from the user device 108 and/or the vehicle HMI 210, and may transmit the request to the system processor 216.

The system processor 216 may obtain the request from the system transceiver 214. The system processor 216 may use the charger finder module 220 to determine the available charging stations and the time to travel from the vehicle current location to each charging station. To determine the available charging stations, the system processor 216 may fetch the charging station information associated with the charging stations 104 (e.g., their real-time availability status and location) from the server, and may determine the available charging stations and the travel time based on the charging station information. In addition, the system processor 216 may determine an added buffer for boosted current.

In addition, the system processor 216 may estimate the desired charging power curve (or the desired charging rate) for each charging station, as described above. For example, based on the user request, the system processor 216 may estimate that the charging rate should be 1.35 C instead of 1 C to boost charge the vehicle battery 202 at a particular available charging station (e.g., the charging station 104a). Responsive to estimating the desired charging power curve, the system processor 216 may estimate an extent of change in the battery SOH due to boost charging of the vehicle battery 202 based on the user request, and may perform a predetermined action based on the extent.

To determine the extent of change in the battery SOH, the system processor 216 may simulate a current boosted charging curve based on the respective desired charging power curve, and simulate a future charging curve based on user's historical charging behavior, via the digital twin simulator 222 as described above. The system processor 216 may then use the battery predictive SOH module 224 to estimate an updated battery SOH due to boost charging of the vehicle battery 202 based on the simulated current boosted charging curve and an original battery SOH (or original battery SOH trajectory, represented by a line 402 in FIG. 4). The system processor 216 may further calculate a first difference between the updated battery SOH and the original battery SOH, and estimate the extent of change in the battery SOH based on the calculated first difference between the updated battery SOH and the original battery SOH.

In some aspects, to perform the predetermined action based on the determined extent, the system processor 216 may use the battery predictive SOH module 224 to estimate a future battery SOH based on the future charging curve and the respective updated battery SOH, for each charging station. The system processor 216 may then calculate a second difference between the respective future battery SOH and the original battery SOH for each charging station, to determine whether that the effect of boost charging may be mitigated or not. The system processor 216 may determine that the effect of boost charging may be mitigated when the second difference is less than the threshold value. In such scenario, the system processor 216 may determine a recommendation to optimally charge the vehicle battery 202 in future based on the future charging curve. The system processor 216 may output the first notification for the user (via the user device 108 and/or the vehicle HMI 210) including the recommendation and information associated with those charging stations having second difference less than the threshold value. The recommendation may include a future vehicle battery charge speed profile to minimize a degradation rate or change in trajectory of the battery SOH due to boost charging or the extent of the boost change on the battery SOH.

On the other hand, the system processor 216 may estimate that the battery health degradation may be high (or the effect may not be mitigated) when the second difference between the future battery SOH and the original battery SOH is greater than the threshold value. In such scenarios, the system processor 216 may use the battery predictive SOH module 224 to calculate the battery warranty score and the total remaining distance based on the current boosted charging curve and the future charging curve (or the updated SOH).

In further aspects, in this case, the system processor 216 may determine the additional resource(s) required to maintain the battery warranty based on the battery score, via the battery warranty bank module 226. The system processor 216 may output the second notification to the user (via the user device 108 and/or the vehicle HMI 210) indicating the additional resource required to maintain the battery warranty. In further aspects, the system processor 216 may determine the reduced mileage based on the battery warranty score and the total distance remaining. The system processor 216 may output the third notification to a user (via the user device 108 and/or the vehicle HMI 210) indicating the reduced mileage. In some aspects, the first notification, the second notification and the third notification may be a part of a single notification, as described above. This single notification may indicate the extent of battery degradation for respective charging station. For example, the single notification may include a list of charging stations along with indications of their respective second difference, the respective battery warranty score, the reduced mileage/additional resource requirement, and travel time to the respective charging station. The user may view the notification and may select one charging station for charging the vehicle 102. In additional aspects, the system processor 216 may determine a rank for each charging station in the list (e.g., rank those charging stations high which will cause least battery degradation), and output the list on the user device 108 and/or the vehicle HMI 210 based on the ranking, so that the user may select an optimal charging station to charge the vehicle 102.

Responsive to outputting the notification, the system processor 216 may obtain a user response to boost charge the vehicle battery 202 at the charging station. The user may accept or reject the offer to boost charge the vehicle battery 202 after receiving and viewing/hearing the notification. When the user rejects the offer, the system processor 216 may not take any further action. On the other hand, when the user accepts the offer, the system processor 216 may perform a second predetermined action to boost a charging current to enable boost charging. In some aspects, the system processor 216 may transmit a command signal to the selected charging station or to the vehicle control unit 212 (e.g., to a charging control module with modified current limits/settings) to boost the charging current.

In further aspects, the system processor 216 may provide a recommendation to swap the vehicle battery 202. For example, for situations where the need for exceptional charging speed is regular during a specific period (seasonal), such as a planned road trip or business travel, a battery swapping recommendation can be provided instead of offering a dynamic battery warranty. For example, Lithium Iron Phosphate (LFP) batteries generally experience lower degradation compared to Lithium Nickel Manganese Cobalt Oxide (NMC) batteries. Therefore, the user may choose to have LFP batteries swapped in during this service period. This option requires that battery swapping technologies are available nearby.

FIG. 4 depicts an example graph 400 illustrating an exemplary effect of a boost charging event on battery SOH in accordance with the present disclosure. The graph 400 includes a Y-axis that represents nominalized capacity associated with the vehicle battery 202, and an X-axis that represents distance in miles. In general, a warranty of the vehicle battery 202 may guarantee 70% capacity retention (defined as end-of-life, EOL) after 100,000 miles, as depicted by line 402.

As described above, the system processor 216, via the battery predictive SOH module 224, determines the degradation in the battery SOH due to boost charging events. A battery SOH is a function of a remaining useable capacity and a useable capacity from new (e.g., the capacity when the battery was new). The battery predictive SOH module 224 may derive the remaining useable capacity (or usable battery capacity) due to boost charging based on the current boosted charging curve, and then determine the updated battery SOH based on the remaining useable capacity and the original battery SOH. In some aspects, the system processor 216 may determine a trajectory of the updated battery SOH due to the boost charging based on the current boosted charging curve, as represented by line 404 in FIG. 4. In some aspects, the system processor 216 may relate the remaining useable capacity (or the trajectory of the updated battery SOH) and determine the total distance remaining. For example, the system processor 216 may determine that due to the boost charging event, the total possible miles left is 99,980 miles (i.e., 70% capacity retention after 99,980 miles instead of 100,000 miles), as depicted by the line 404. In this manner, the system processor 216 determines the total distance remaining by using the current boosted charging curve.

The system processor 216 may use the simulated future charging curve and determine if the updated battery SOH (or the trajectory of the updated battery SOH, as depicted by the line 404 in FIG. 4) can get back to the original battery SOH, as depicted by the line 406 in FIG. 4. Responsive to a determination that the updated battery SOH for a charging station can get back to the original battery SOH (or the trajectory of the original battery SOH), the system processor 216 may output the first notification and recommend the future charging profiles to the user (that may be based on the simulated future). On the other hand, responsive to a determination that the updated battery SOH cannot get back to the original battery SOH (even after following the future charging curve), the system processor 216 may output the second notification and/or the third notification.

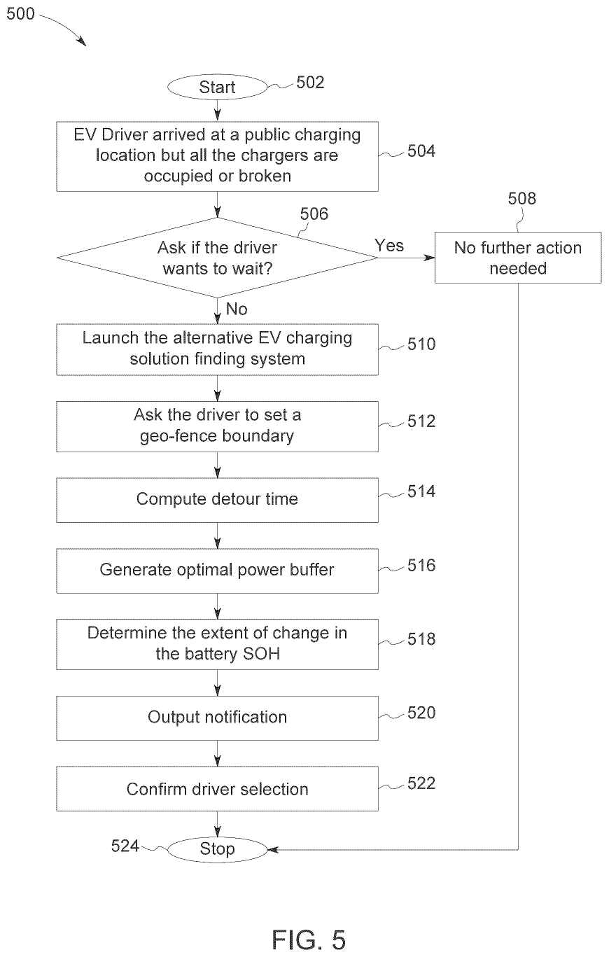

FIG. 5 depicts a flow diagram of an example first method 500 to optimize vehicle charging in accordance with the present disclosure. The example depicted in FIG. 5 starts at step 502. In this example, the vehicle battery 202 may have a usable battery capacity of 91 kWh, and the user may be required to reach a destination at 11 AM for a business engagement. The user may need to charge the vehicle battery 202 from 20% to 80%, which is about 54.6 kWh. For a CCS charger with 150 kW, the user may normally get around 88 kW, depending on the battery's SOC. So approximately, in this case, the user may need 37 minutes to charge from 20% to 80%.

In an exemplary aspect, when the user arrives at a public charging location, all the chargers may be occupied or broken, as depicted by step 504. In this case, the system processor 216 may output a notification to check if the user wants to wait, as depicted by step 506. When the user desires to wait, the system processor 216 may not take any further action, as depicted by step 508. On the other hand, when the user does not want to wait, the system processor 216 may launch alternative EV charging solution finding system (e.g., the system 200), as depicted by step 510. Responsive to launching the alternative EV charging solution finding system, the system processor 216 may ask the user to set a geo-fence boundary, as depicted by step 512. The system processor 216, via the charger finder module 220, may obtain the geo-fence boundary, and compute detour time for each available charging station, as depicted by step 514.

For all the charging stations, the system processor 216 may generate an optimal power buffer (or the desired charging power curve), as depicted by step 516. For instance, the system processor 216 may generate the optimal power buffer based on distance to destination, current battery thermal conditions, grid limitations, etc. For example, the system processor 216 may determine that there may be another charging station location 8 minutes away, and detouring from the vehicle's current location to the other charging station and then heading to the destination may waste 10 minutes. To save 10 minutes, the new charging time may need to be around 27 minutes, requiring an associated charging power of around 121 kW. Stated another way, instead of using a 1 C charging rate, the charging needs to be boosted to 1.35 C.

The system processor 216 may use the digital twin simulator 222 and the battery predictive SOH module 224 to determine the extent of change in the battery SOH due to this boost charging event at around 121 kW or 1.35 C, as depicted by step 518. Based on the determined extent of change in the battery SOH, the system processor 216 may output a notification, as depicted by step 520. For example, system processor 216 may output a notification indicating that the boost charging is doable but requires 5-10 mild charging profiles in the following charging events to mitigate the SOH impairment generated from this alternative charging solution. Responsive to outputting the notification, the system processor 216 may obtain the driver's selection, as depicted by step 522, and may perform the action accordingly (e.g., the second predefined action described above). The method 500 stops at step 524.

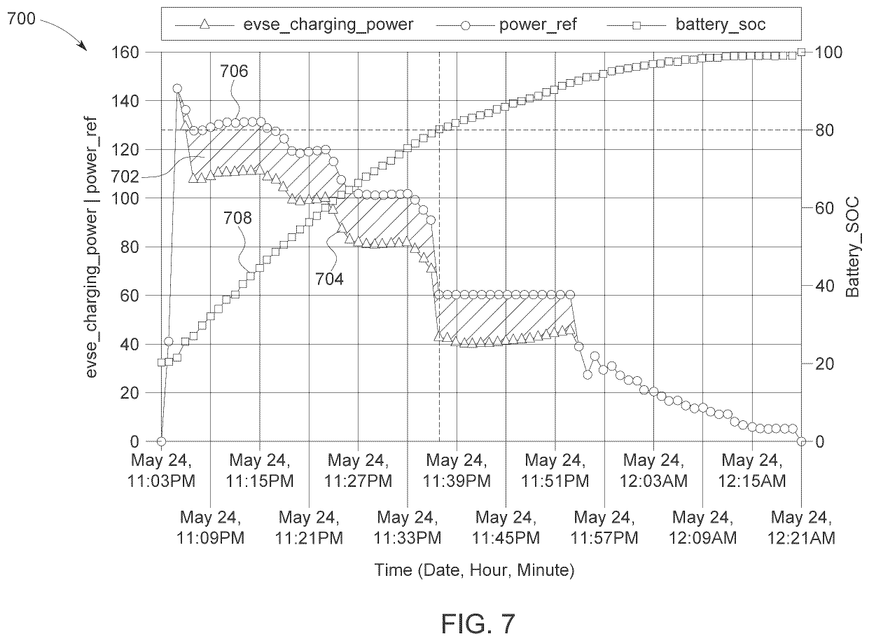

FIG. 6 depicts an example view 600 of interaction between the vehicle 102 and the charging station 104 for boost charging in accordance with the present disclosure. FIG. 6 will be described in conjunction with FIG. 7.

In some aspects, the vehicle 102 may include a plurality of components including, but not limited to, a battery charge control module (BCCM) 602, a battery energy control module (BECM) 604, and an off-board charge control module (OBCC) 606. The BCCM 602 is the first module that receives a communication signal from a charging station via a control pilot wire 608. The OBCC 606 may be responsible for managing communications with the charging station 104 (or EVSE) using a high-level digital protocol. The BECM 604 may ensure the health and longevity of the vehicle battery 202 by monitoring and balancing cells to prevent overcharge or over-discharge, calculating the battery's SOC, and managing the main contactors, allowing vehicle loads to use battery power when needed. During a charging session, the BECM 604 may communicate power requirements via CAN 610 to either the OBCC 606 (for DC charging) or the BCCM 602 (for AC charging). In some aspects, the BECM 604 may determine the maximum current or voltage limit to charge the vehicle battery 202, which may be based on the battery SOC level, the battery SOH, cell voltage and temperature.

To supply the boosted current to the vehicle battery 202 for boost charging, the system processor 216 may transmit a command signal to the vehicle 102 or to the EVSE. For instance, the system processor 216 may transmit the command signal to the OBCC 606 (or any other component) to charge the vehicle battery 202 at a target current/voltage. The OBCC 606 may receive the command signal and may generate a request and transmit the request for the EVSE. The connector 612, which may be managed by a supply equipment communication controller (SECC) 614, may receive the request and may output the target current.

In some aspects, the EVSE may allow dynamic current adjustment (based on the request to facilitate boost charging) by optimizing liquid-cooled cable controls (having small buffer room), or by managing other EVSEs in the same region to provide higher current while lowering other EVSEs to satisfy grid supply needs (in which the buffer room depends on grid energy management). In further aspects, the vehicle 102 may allow dynamic current adjustment by optimizing the cooling and heating of cells, cabin conditioning, and/or drive cycles before and after charging. In this case, the buffer room is moderate and also depends on the season and battery condition. In addition, the vehicle 102 may manage battery SOH buffer by increasing the charging C rate, as indicated by area 702 in a boosted charging graph 700 of FIG. 7. The graph 700 includes an X axis that represents time (e.g., in date, hour, minute), a first Y axis that represents EVSE charging power/power reference, and a second Y axis that represents battery SOC. The graph 700 includes a first line 704 indicating EVSE charging power, a second line 706 indicating reference power, and a third line 708 indicating battery SOC level. The area 702 may be a difference between the first line 704 and the second line 706. In this case, the buffer room is moderate and can be quantified with a good SOH model.

In some aspects, the EVSE (e.g., a first EVSE) may be configured to share power with another EVSE (or second EVSE), where the first EVSE and the second EVSE may be part of a ChargePoint. The first EVSE and the second EVSE may be configured to supply power simultaneously. Typically, the power is split evenly between the two. In some aspects, the system processor 216 may transmit a command signal to the first EVSE and/or the second EVSE to enable uneven power sharing, to enable boost charging of the vehicle battery 202. In some aspects, the system processor 216 may reward the first EVSE and/or the second EVSE. In addition, the system processor 216 may reward the first EVSE and/or the second EVSE when the first EVSE and/or the second EVSE support enhanced charging communication, such as Plug&Charge, EVSE reservations, remote activation, etc.

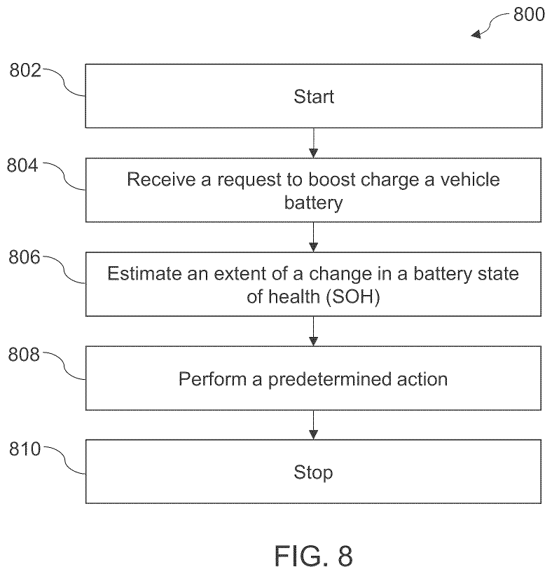

FIG. 8 depicts a flow diagram of a vehicle charging optimization method 800 in accordance with the present disclosure. FIG. 8 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 800 starts at step 802. At step 804, the method 800 may include obtaining, by the system processor 216, a request to boost charge the vehicle battery 202. The request may include information associated with a target SOC level, a predefined time by which the target SOC level is required, and/or a minimum distance required to reach a destination. At step 806, the method 800 may include estimating, by the system processor 216, an extent of a change in a battery SOH due to boost charging of the vehicle battery 202 based on the request. At step 808, the method 800 may include performing, by the system processor 216, a predetermined action based on the extent. The examples of the predetermined action are described above. After the step 808, the method 800 may move to step 810, at which the method 800 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
a transceiver configured to receive a request to boost charge a vehicle battery associated with a vehicle, wherein the request comprises information associated with at least one of a target State of Charge (SOC) level, a predefined time by which the target SOC level is required, or a minimum distance required to reach a destination; and
a processor configured to:
estimate an extent of a change in a battery state of health (SOH) due to boost charging of the vehicle battery based on the request; and
perform a predetermined action based on the extent.

2. The system of claim 1, wherein the transceiver is configured to receive the request from a user via a user device or a vehicle Human Machine Interface (HMI).

3. The system of claim 2, wherein the processor is further configured to determine a charging station that is available to charge the vehicle and a time to travel from a vehicle current location to the charging station.

4. The system of claim 3, wherein the processor is further configured to estimate a desired charging power curve associated with the charging station based on the request and the time to travel from the vehicle current location to the charging station.

5. The system of claim 4, wherein the processor is further configured to estimate the desired charging power curve based on a vehicle battery current parameter.

6. The system of claim 5, wherein the vehicle battery current parameter comprises a current battery SOC level.

7. The system of claim 5, wherein the processor is further configured to:
simulate a current boosted charging curve based on the desired charging power curve; and
simulate a future charging curve based on user's historical charging behavior.

8. The system of claim 7, wherein, to estimate the extent of change in the battery SOH, the processor is configured to:
estimate an updated battery SOH due to boost charging of the vehicle battery based on the current boosted charging curve and an original battery SOH;
calculate a difference between the updated battery SOH and the original battery SOH; and
estimate the extent of the change in the battery SOH based on the difference between the updated battery SOH and the original battery SOH.

9. The system of claim 8, wherein, to perform the predetermined action, the processor is configured to:
estimate a future battery SOH based on the future charging curve and the updated battery SOH;
calculate a difference between the future battery SOH and the original battery SOH; and
store the future charging curve in a system memory when the difference between the future battery SOH and the original battery SOH is less than a threshold value.

10. The system of claim 9, wherein the processor is further configured to:
determine a recommendation to charge the vehicle battery in future based on the future charging curve, when the difference between the future battery SOH and the original battery SOH is less than the threshold value; and
output a first notification for the user indicating the recommendation.

11. The system of claim 10, wherein the recommendation comprises a future vehicle battery charge speed profile to minimize a degradation rate or change in trajectory of the battery SOH due to boost charging.

12. The system of claim 10, wherein the first notification further comprises information associated with the charging station.

13. The system of claim 9, wherein, to perform the predetermined action, the processor is configured to calculate a battery warranty score and a total distance remaining based on the updated battery SOH, when the difference between the future battery SOH and the original battery SOH is greater than the threshold value.

14. The system of claim 13, wherein the processor is further configured to determine an additional resource required to maintain a battery warranty based on the battery warranty score.

15. The system of claim 14, wherein the processor is further configured to output a second notification for the user indicating the additional resource required to maintain the battery warranty.

16. The system of claim 13, wherein the processor is further configured to determine a reduced mileage associated with the vehicle based on the battery warranty score and the total distance remaining.

17. The system of claim 16, wherein the processor is further configured to output a third notification for the user indicating the reduced mileage.

18. The system of claim 3, wherein the processor is further configured to:
obtain a user response to boost charge the vehicle battery at the charging station responsive to performing the predetermined action; and
transmit a command signal to the charging station or a vehicle electronic control unit to boost a charging current to enable the boost charging based on the user response.

19. A method comprising:
estimating, by a processor, an extent of a change in a battery state of health (SOH) due to boost charging of a vehicle battery associated with a vehicle based on a request to boost charge the vehicle battery, wherein the request comprises information associated with at least one of a target State of Charge (SOC) level, a predefined time by which the target SOC level is required, or a minimum distance required to reach a destination; and
performing, by the processor, a predetermined action based on the extent.

20. A non-transitory computer-readable storage medium having instructions stored thereupon which, when executed by a processor, cause the processor to:
estimate an extent of a change in a battery state of health (SOH) due to boost charging of a vehicle battery associated with a vehicle based on a request to boost charge the vehicle battery, wherein the request comprises information associated with at least one of a target State of Charge (SOC) level, a predefined time by which the target SOC level is required, or a minimum distance required to reach a destination; and
perform a predetermined action based on the extent.
